(19) United States
(12) Patent Application Publication
(10) Pub. No.: US 2020/0204043 A1
(43) Pub. Date: Jun. 25, 2020

(54) SADDLE TYPE ELECTRIC VEHICLE

(71) Applicant: HONDA MOTOR CO., LTD., Tokyo (JP)

(72) Inventor: Satoshi Matsushima, Wako-shi (JP)

(21) Appl. No.: 16/672,586

(22) Filed: Nov. 4, 2019

(30) Foreign Application Priority Data
Dec. 25, 2018 (JP) 2018-241759

(51) Int. Cl. H02K 9/19; B60L 50/60; B62K 11/04

(52) U.S. Cl. CPC H02K 9/19; B62K 2204/00; B62K 11/04; B60L 50/60

(57) ABSTRACT

An electric motorcycle includes a power unit including a motor which is configured to drive a vehicle, a battery which is a power source of the motor, and a PCU which is configured to control the motor; and a vehicle body frame having a storage portion which supports the power unit and in which cooling water flowing in the power unit is stored.

### CROSS-REFERENCE TO RELATED APPLICATION

Priority is claimed on Japanese Patent Application No. 2018-241759, filed Dec. 25, 2018, the content of which is incorporated herein by reference.

### BACKGROUND OF THE INVENTION

### Field of the Invention

The present invention relates to a saddle type electric vehicle.

### Description of Related Art

As a saddle type electric vehicle, there is a vehicle including a driving motor and a cooling device which includes a radiator, a pump, or the like and cools the motor. PCT International Publication No. WO2015/049711 discloses an electric motorcycle in which an oil cooler for cooling oil using traveling wind is disposed in front of a motor unit.

### SUMMARY OF THE INVENTION

Incidentally, in a saddle type electric vehicle, it is necessary to improve cooling performance as an output becomes higher. On the other hand, a battery, a control unit, and the like are assumed to be used at a sufficiently low temperature as compared with an engine. Also, the motor generates less heat than the engine. Therefore, even when cooling water is constantly circulated through the battery, the control unit, the motor, or the like, a temperature of the cooling water does not increase much, and a temperature difference with external air is small Thus, it is difficult to obtain an effect in which the cooling water is cooled by heat radiation in a radiator. On the other hand, in the battery, the control unit, the motor, or the like, since the temperature tends to suddenly increase at a high output, it is desired to supply the cooling water which is sufficiently stored and cooled at a necessary timing while reducing the number of components by omitting the radiator.

Therefore, the present invention provides a saddle type electric vehicle in which an increase in an amount of stored cooling water and a reduction in the number of components are promoted.

A saddle type electric vehicle according to a first aspect of the present invention includes a power unit (8) including a motor (50) which is configured to drive the vehicle, a battery (100) which is a power source of the motor (50), and a control unit (130) which is configured to control the motor (50); and a vehicle body frame (5) which supports the power unit (8) and in which a storage portion (91; 191; 291) configured to store cooling water flowing through an inside of the power unit (8) is formed.

According to the saddle type electric vehicle according to the first aspect, a storage amount of the cooling water can be increased without separately providing a tank or the like for storing the cooling water at a location other than the vehicle body frame. Therefore, the storage amount of the cooling water can be increased, the number of components can be reduced, and the cooled cooling water can be supplied to the power unit at a necessary timing.

In a saddle type electric vehicle according to a second aspect of the present invention, in the saddle type electric vehicle according to the first aspect, the storage portion (91; 191; 291) may include an outlet port (92; 192; 292) through which the cooling water flows out toward the power unit (8), and an inflow port (93; 193; 293) which is provided above the outlet port (92; 192; 292) and through which the cooling water discharged from the power unit (8) flows in.

According to the saddle type electric vehicle according to the second aspect, the high-temperature cooling water returned from the power unit to the storage portion can remain above the outlet port in the storage portion due to a density difference based on a temperature difference of the cooling water. Therefore, even in a state in which the cooling water heated in the power unit is returned to the storage portion, relatively low-temperature cooling water can be supplied from the storage portion to the power unit. Thus, the cooled cooling water can be supplied to the power unit at a necessary timing.

In a saddle type electric vehicle according to a third aspect of the present invention, in the saddle type electric vehicle according to the first or second aspect, the vehicle body frame (5) may include a head pipe (16) which supports a front wheel (2) to be steerable, a pair of right and left main pipes (17) which extend rearward from the head pipe (16), and a down tube (19) which extends downward from the head pipe (16), at least a part of the power unit (8) may be disposed between the pair of main pipes (17) and the down tube (19), and the storage portion (91; 191; 291) may be formed in at least one of the main pipes (17) and the down tube (19).

According to the saddle type electric vehicle according to the third aspect, since the storage portion is close to the power unit, it is possible to prevent an increase in a length of the pipe and to curb an increase in a weight of the vehicle.

In a saddle type electric vehicle according to a fourth aspect of the present invention, the saddle type electric vehicle according to any one of the first to third aspects may further include a pipe (97) which connects the storage portion (91; 191; 291) to the power unit (8) and in which the cooling water flows, a pump (95) which is configured to circulate the cooling water between the storage portion (91; 191; 291) and the power unit (8), and a high-voltage electric wire (120) which extends from the battery (100), the high-voltage electric wire (120) may be disposed on one side of a center of a vehicle width in a vehicle width direction, the pump (95) may be disposed on the same side of the center of the vehicle width as the high-voltage electric wire (120), and the pipe (97) may be connected to the power unit (8) on a side of the center of the vehicle width opposite to the high-voltage electric wire (120).

According to the saddle type electric vehicle according to the fourth aspect, as compared with a case in which the pipe is connected to the power unit on the same side of the center of the vehicle width as the high-voltage electric wire and the pump, it is possible to suppress the weight balance between the right and left sides of the vehicle from being biased.

### BRIEF DESCRIPTION OF THE DRAWINGS

FIG. 1 is a left side view of an electric motorcycle according to a first embodiment.

FIG. 2 is a right side view showing a part of the electric motorcycle according to the first embodiment.

FIG. 3 is a front view of a power unit of the first embodiment.

FIG. 4 is a perspective view of a part of the electric motorcycle according to the first embodiment when seen from the left front side.

FIG. 5 is a perspective view of a vehicle body frame and a cooling system in the electric motorcycle according to the first embodiment when seen from the right rear side.

FIG. 6 is a perspective view of a part of an electric motorcycle according to a modified example of the first embodiment when seen from the left front side.

FIG. 7 is a perspective view of a vehicle body frame and a cooling system in the electric motorcycle according to the modified example of the first embodiment when seen from the right rear side.

FIG. 8 is a perspective view of a part of an electric motorcycle according to a second embodiment when seen from the left front side.

FIG. 9 is a perspective view of a vehicle body frame and a cooling system in the electric motorcycle according to the second embodiment when seen from the right rear side.

FIG. 10 is a perspective view of a part of an electric motorcycle according to a third embodiment when seen from the left front side.

FIG. 11 is a perspective view of a vehicle body frame and a cooling system in the electric motorcycle according to the third embodiment when seen from the right rear side.

### DETAILED DESCRIPTION OF THE INVENTION

Hereinafter, embodiments of the present invention will be described with reference to the drawings. In the following description, directions such as forward and rearward, upward and downward, and right and left are the same as directions in a vehicle described below. That is, upward and downward directions coincide with a vertical direction, and right and left directions coincide with a vehicle width direction. In the vehicle width direction, a direction away from a center of a vehicle width is referred to as outward in the vehicle width direction. Further, in the drawings used for the following description, an arrow UP indicates an upward direction, an arrow FR indicates a forward direction, and an arrow LH indicates a leftward direction.

### First Embodiment

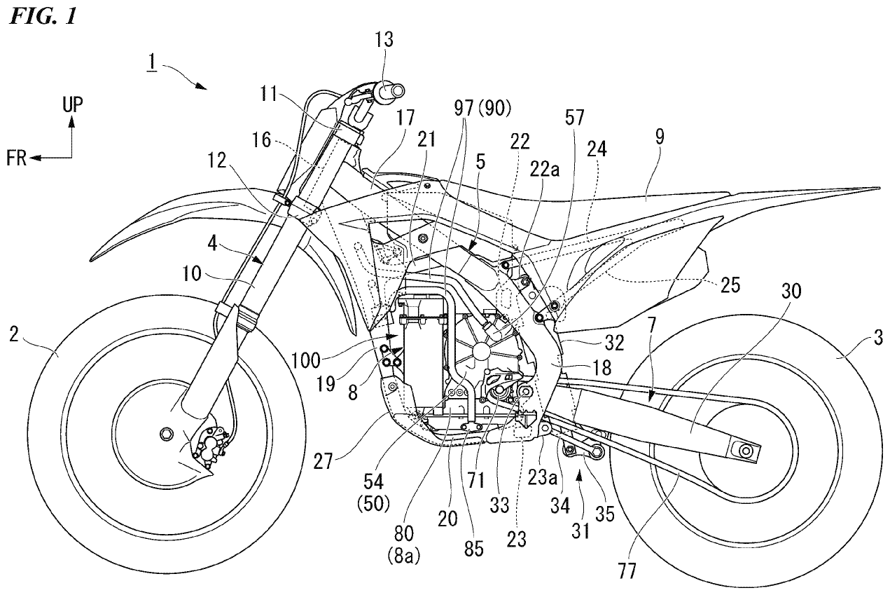

FIG. 1 is a left side view of an electric motorcycle according to a first embodiment. As shown in FIG. 1, the electric motorcycle 1 of the embodiment is an off-road saddle type electric vehicle. The electric motorcycle 1 includes a front wheel 2, a rear wheel 3, a front wheel suspension system 4, a vehicle body frame 5, a rear wheel suspension system 7, a power unit 8, a seat 9, and a cooling system 90.

The front wheel suspension system 4 includes a pair of right and left front forks 10 which pivotally support the front wheel 2 at lower end portions thereof, a top bridge 11 and a bottom bridge 12 which are provided between upper portions of the pair of front forks 10, a steering stem (not shown) which is provided between the top bridge 11 and the bottom bridge 12 and inserted through a head pipe 16, and a steering handle 13 supported on the top bridge 11. The front wheel 2 is supported by the head pipe 16 of the vehicle body frame 5 through the front wheel suspension system 4 to be steerable.

The vehicle body frame 5 includes the head pipe 16, a pair of right and left main pipes 17, a pair of right and left pivot frames 18, a single down tube 19, a pair of right and left lower frames 20, a pair of right and left gussets 21, a cross member 22, and a lower cross member 23, and they are joined together by welding or the like.

The head pipe 16 is provided at a front end of the vehicle body frame 5. The head pipe 16 supports the steering stem. The pair of main pipes 17 branch right and left from an upper portion of the head pipe 16 and extend rearward and downward. The pair of main pipes 17 are coupled to each other at front end portions thereof. The pair of main pipes 17 are curved and extend to swell outward in the vehicle width direction behind the head pipe 16 in a plan view when seen from above. The pair of pivot frames 18 extend downward from rear end portions of the main pipes 17. A pivot shaft 33 which extends in the vehicle width direction is installed between lower portions of the pair of pivot frames 18. The down tube 19 extends downward from a lower portion of the head pipe 16. The pair of lower frames 20 branch right and left from a lower end portion of the down tube 19, extend rearward, and are connected to lower end portions of the pivot frames 18.

The pair of gussets 21 connect the main pipes 17 to the down tube 19 above a motor 50 of the power unit 8. The pair of gussets 21 branch right and left from a middle portion of the down tube 19, extend rearward, and are connected to middle portions of the main pipes 17. The term “middle” used in the embodiment is intended to include not only a center between both ends of a target but also an inner range between both ends of the target. The cross member 22 extends in the vehicle width direction and connects upper portions of the pair of pivot frames 18 to each other. A cushion support bracket 22a which extends rearward and upward is fixedly provided at a center portion of the cross member 22 in the vehicle width direction. A rear cushion 32 which will be described later is connected to the cushion support bracket 22a. The lower cross member 23 extends in the vehicle width direction and connects lower end portions of the pair of pivot frames 18 to each other below the pivot shaft 33. A link support bracket 23a which extends rearward is fixedly provided at the lower cross member 23. A link arm 34 which will be described later is connected to the link support bracket 23a.

The vehicle body frame 5 further includes a pair of right and left seat rails 24 and a pair of right and left support rails 25. The pair of seat rails 24 are connected to upper end portions of the pivot frames 18 and extend rearward and upward from the pivot frames 18. The pair of seat rails 24 support the seat 9 from below. The pair of support rails 25 are connected to the pivot frames 18 below the seat rails 24. The pair of support rails 25 extend rearward and upward from the pivot frames 18 and are connected to the seat rails 24.

The vehicle body frame 5 is a semi-double cradle type. The power unit 8 including the motor 50 and a battery 100 is mounted on the vehicle body frame 5 below the right and left main pipes 17 behind the head pipe 16 and in front of the right and left pivot frames 18. The vehicle body frame 5 surrounds the power unit 8 from the front side and the lower side by the single down tube 19 and the right and left lower frames 20.

The rear wheel suspension system 7 includes a swing arm 30 which pivotally supports the rear wheel 3 at a rear end portion, a link mechanism 31 which is connected between a front portion of the swing arm 30 and the lower portions of the pair of pivot frames 18, and the rear cushion 32 which extends between the link mechanism 31 and the cross member 22.

The swing arm 30 is provided below a rear portion of the vehicle body. The swing arm 30 extends forward and rearward. A front end portion of the swing arm 30 is supported by the pair of pivot frames 18 via the pivot shaft 33 to be vertically swingable.

The link mechanism 31 includes a link arm 34 and a link member 35. The link arm 34 is provided below the swing arm 30 in a side view. The link arm 34 extends forward and rearward. A front end portion of the link arm 34 is rotatably connected to the link support bracket 23a of the lower cross member 23. The link member 35 is formed in a triangular shape in a side view. An upper portion of the link member 35 is rotatably connected to a middle portion of the swing arm 30 in forward and rearward directions. A rear lower portion of the link member 35 is rotatably connected to a rear end portion of the link arm 34. The rear cushion 32 is connected to a front portion of the link member 35.

The rear cushion 32 is provided at a center of the rear portion of the vehicle body in the vehicle width direction. The rear cushion 32 is formed in a cylindrical shape. The rear cushion 32 extends vertically when seen from the rear side. The rear cushion 32 is inclined forward so that an upper end portion thereof is located forward from a lower end portion. The upper end portion of the rear cushion 32 is rotatably connected to the cushion support bracket 22a of the cross member 22. A lower end portion of the rear cushion 32 is rotatably connected to the front portion of the link member 35.

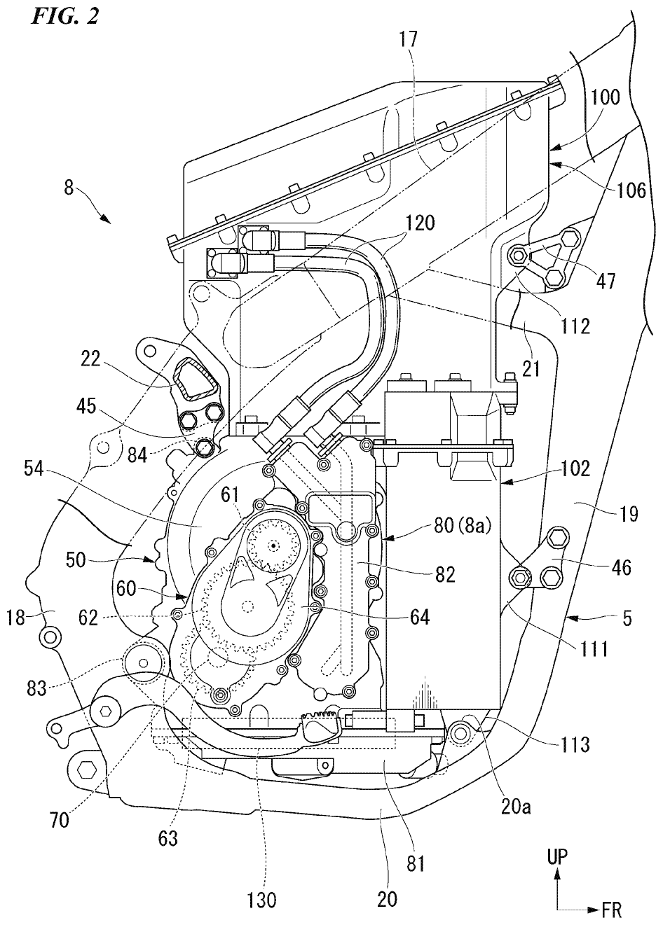

FIG. 2 is a right side view showing a part of the electric motorcycle according to the first embodiment. As shown in FIG. 2, the power unit 8 includes the motor 50 for driving the vehicle, a speed reducer 60 which decelerates an output of the motor 50, an output shaft 70 which outputs power of the motor 50 decelerated in the speed reducer 60, the battery 100 which is a power source of the motor 50, a power control unit (PCU) 130 which controls the motor 50, a housing 80 which accommodates a driving unit for the motor 50 and the speed reducer 60 and the PCU 130, and a high-voltage electric wire 120 which extends from the battery 100 and is connected to the PCU 130. The power unit 8 is fixed to and supported by the vehicle body frame 5. The power unit 8 is disposed behind the down tube 19 in a side view and above the lower frames 20. Further, the power unit 8 is disposed to be sandwiched by the pair of main pipes 17 and the pair of pivot frames 18 from the outside in the vehicle width direction. At least a part of the power unit 8 is disposed between the pair of main pipes 17 and the down tube 19. A lower portion of the power unit 8 is covered with an under cover 27 installed at the lower frame 20 (refer to FIG. 1).

The motor 50, the speed reducer 60, the output shaft 70, the PCU 130, and the housing 80 are integrally unitized as a driving device 8a. The motor 50 is disposed at a rear portion of the power unit 8. The speed reducer 60 is disposed outside (on the right side of) the motor 50 in the vehicle width direction. The PCU 130 is disposed below the motor 50. The housing 80 forms an outline of the driving device 8a. The driving device 8a is formed to be cooled by cooling water flowing through the inside thereof (details will be described later).

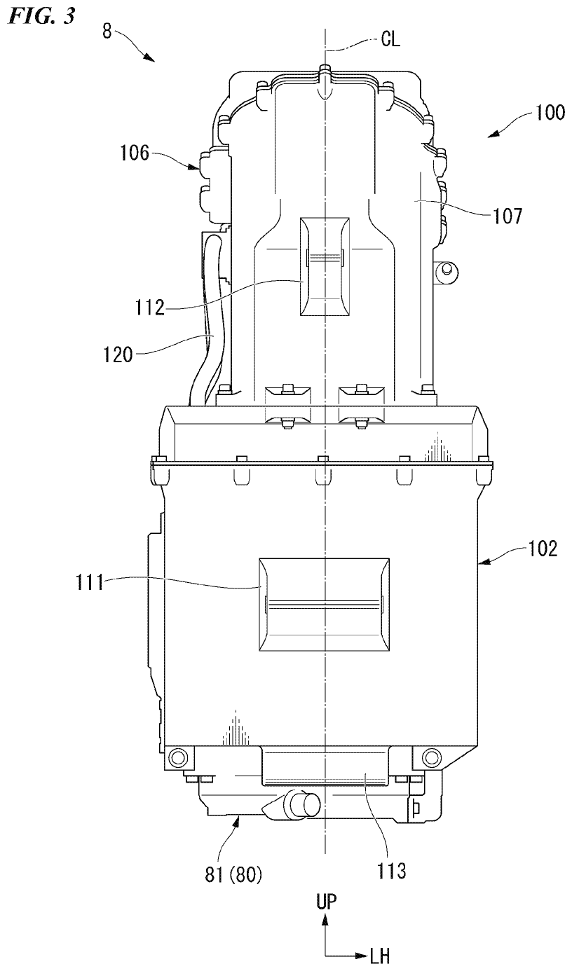

The motor 50 is disposed on the center CL of the vehicle width (refer to FIG. 3). The center CL of the vehicle width is an imaginary line which overlaps a center axis of the head pipe 16 when seen in the forward and rearward direction. The motor 50 includes a stator and a rotor (not shown), and a motor case 54 which accommodates the stator and the rotor. The motor case 54 is a part of the housing 80 and forms an outline of the motor 50.

The speed reducer 60 is disposed on the right side of the motor 50. The speed reducer 60 includes a driving gear 61 fixed to a motor shaft (not shown) of the motor 50, a reduction gear 62 which is a two-stage gear engaging with the driving gear 61, a driven gear 63 which is fixed to the output shaft 70 and engages with the reduction gear 62, and a speed reducer case 64 which accommodates the driving gear 61, the reduction gear 62, and the driven gear 63. The speed reducer case 64 is a part of the housing 80 and forms an outline of the speed reducer 60.

The output shaft 70 is disposed below and behind the motor 50. The output shaft 70 extends in the vehicle width direction and is rotatably supported by the housing 80. The above-described driven gear 63 is fixed to a right end of the output shaft 70. A front sprocket 71 (refer to FIG. 1) is fixed to a left end of the output shaft 70. As shown in FIG. 1, a chain 77 which is a transmission mechanism disposed on the left side of the rear portion of the vehicle body is wound around the front sprocket 71. The chain 77 is wound around a rear sprocket on the left side of the rear wheel 3. Thus, the output of the motor 50 is transmitted to the rear wheel 3.

As shown in FIG. 2, the housing 80 includes a PCU case 81 which accommodates the PCU 130, and a cable case 82 which covers the high-voltage electric wire 120, in addition to the motor case 54 and the speed reducer case 64 described above. The PCU case 81 is disposed below the motor case 54. The PCU case 81 has a cavity therein, and the PCU 130 is accommodated in the cavity. The PCU case 81 protrudes forward with respect to the motor case 54. The cable case 82 is disposed on the right side of the motor case 54. The cable case 82 covers the high-voltage electric wire 120 from the outside in the vehicle width direction.

As shown in FIG. 1, a discharge port 57 and an introduction port 85 are provided in the housing 80. The discharge port 57 is provided in a left surface of the motor case 54. The introduction port 85 is provided in a left surface of the PCU case 81 (refer to FIG. 2). The discharge port 57 and the introduction port 85 are provided in a range surrounded by the main pipe 17, the pivot frame 18, the down tube 19, and the lower frame 20 of the vehicle body frame 5 in a side view. The introduction port 85 is provided below the discharge port 57. The introduction port 85 receives the above-described cooling water. The cooling water introduced from the introduction port 85 flows in the PCU case 81, the speed reducer case 64, and the motor case 54 and is discharged from the discharge port 57.

As shown in FIG. 2, the housing 80 includes a lower support portion 83 and an upper support portion 84 which are supported by the vehicle body frame 5. The lower support portion 83 protrudes rearward from a rear lower portion of the housing 80. A through hole through which the pivot shaft 33 is inserted is formed in the lower support portion 83. The lower support portion 83 is supported by the pivot frame 18 via the pivot shaft 33. The upper support portion 84 protrudes rearward and upward from a rear upper portion of the housing 80. The upper support portion 84 is supported by the cross member 22 via a pair of right and left first mount brackets 45.

The battery 100 is located at a front portion and an upper portion of the power unit 8. The battery 100 is disposed in front of and above the motor 50. The battery 100 includes a lower battery 102 and an upper battery 106. The lower battery 102 and the upper battery 106 are fastened to each other.

FIG. 3 is a front view of the power unit of the first embodiment.

As shown in FIGS. 2 and 3, the lower battery 102 is located in front of the motor 50. The lower battery 102 is formed in a rectangular parallelepiped shape having sides extending in the vertical direction, sides extending in the forward and rearward direction, and sides extending in the vehicle width direction. The lower battery 102 is disposed to overlap the center L of the vehicle width when seen in the forward and rearward direction. A lower end portion of the lower battery 102 is fastened to the PCU case 81.

The upper battery 106 is located above the motor 50 and the lower battery 102. The upper battery 106 is disposed between the pair of main pipes 17. The upper battery 106 is disposed between the pair of gussets 21. The upper battery 106 is formed to be larger than the lower battery 102 in the forward and rearward direction. The upper battery 106 is disposed to overlap the center CL of the vehicle width when seen in the forward and rearward direction. The upper battery 106 extends in the vertical direction with a substantially constant width when seen in the forward and rearward direction. The upper battery 106 is formed to be smaller than the lower battery 102 in the vehicle width direction. Thus, the lower battery 102 protrudes further than both sides of the upper battery 106 in the vehicle width direction. A front portion of the upper battery 106 is fastened to the lower battery 102. A rear portion of the upper battery 106 is fastened to an upper portion of the motor case 54 and a rear upper portion of the lower battery 102.

The battery 100 includes a front surface lower support portion 111, a front surface upper support portion 112, and a lower surface support portion 113 which are supported by the vehicle body frame 5. The front surface lower support portion 111 protrudes forward from a front surface of the lower battery 102 and extends in the vehicle width direction. The front surface lower support portion 111 is supported by the down tube 19 via a pair of right and left second mount brackets 46. The front surface upper support portion 112 protrudes forward from a front surface of the upper battery 106 and extends in the vehicle width direction. The front surface upper support portion 112 is supported by the down tube 19 via a pair of right and left third mount brackets 47. The lower surface support portion 113 protrudes downward from a lower surface of the lower battery 102 and extends in the vehicle width direction. The lower surface support portion 113 is fastened to a pair of extending portions 20a which extend from the pair of lower frames 20.

As shown in FIG. 2, the PCU 130 is a control device including a power drive unit (PDU) which is a motor driver, an electric control unit (ECU) which controls the PDU, and the like. The PDU includes an inverter, converts a current supplied from the battery 100 from a direct current to an alternating current and then supplies the converted current to the motor 50. The PCU 130 is accommodated in the PCU case 81 of the housing 80.

The high-voltage electric wire 120 is disposed on the same side (that is, on the right side) of the center CL of the vehicle width (refer to FIG. 3) as the speed reducer 60. The high-voltage electric wire 120 is disposed to overlap the battery 100 or the motor 50 when seen in the vehicle width direction. The high-voltage electric wire 120 extends from a right surface of the rear portion of the upper battery 106. The high-voltage electric wire 120 extends along outer surfaces of the motor 50 and the upper battery 106. The high-voltage electric wire 120 extends toward the PCU 130. The high-voltage electric wire 120 is covered with the cable case 82 at a position overlapping the motor 50 when seen in the vehicle width direction.

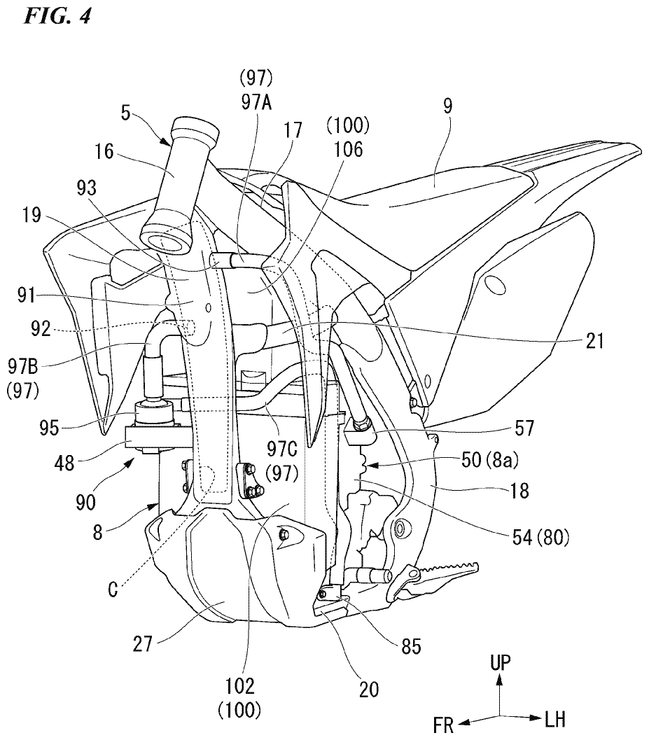

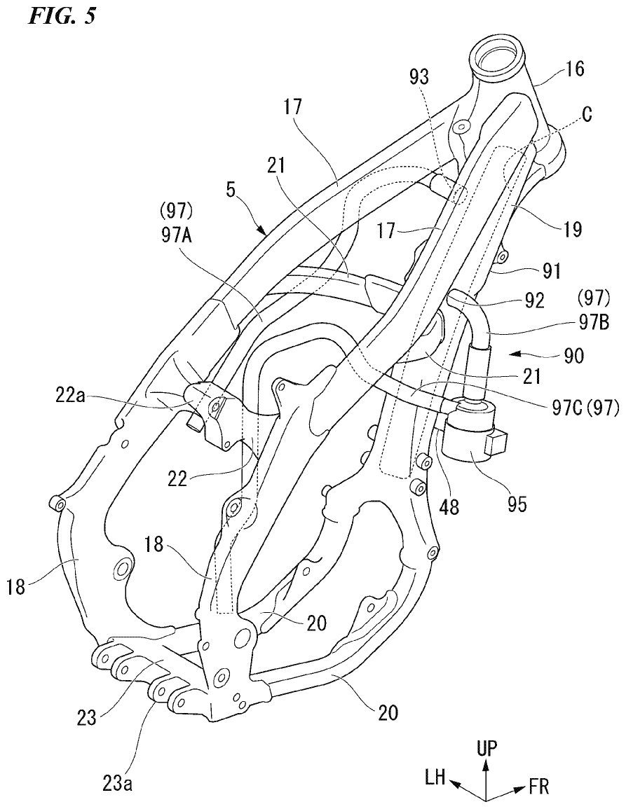

FIG. 4 is a perspective view of a part of the electric motorcycle according to the first embodiment when seen from the left front side. FIG. 5 is a perspective view of the vehicle body frame and the cooling system in the electric motorcycle according to the first embodiment when seen from the right rear side. As shown in FIGS. 4 and 5, the cooling system 90 cools the power unit 8 by circulating the cooling water in the power unit 8. The cooling system 90 allows the cooling water to flow in the power unit 8 through a circulation path which does not pass through a heat exchanger such as a radiator. The cooling system 90 includes a storage portion 91 which stores the cooling water, a pump 95 which pumps the cooling water, and a pipe 97 which forms the circulation path of the cooling water.

The storage portion 91 is formed in the vehicle body frame 5. In the embodiment, the storage portion 91 is formed in the down tube 19. The storage portion 91 is formed by allowing the cooling water to be stored inside the down tube 19. For example, a cavity C of the storage portion 91 extends continuously from an upper end portion of the down tube 19 to the lower end portion thereof. That is, the storage potion 91 is provided from the upper end portion of the down tube 19 to the lower end portion thereof. The cavity C of the storage portion 91 is an independent cavity which is not in communication with other cavities in the vehicle body frame 5.

The storage portion 91 includes an outlet port 92 through which the cooling water flows out toward the power unit 8, and an inlet port 93 through which the cooling water discharged from the power unit 8 flows in. The pipe 97 is connected to the outlet port 92 and the inlet port 93. The outlet port 92 and the inlet port 93 are respectively in communication with the inside and the outside of the storage portion 91. The outlet port 92 is provided above a connecting portion of the down tube 19 with the pair of gussets 21. The outlet port 92 opens to the same side (that is, the right side) of the center CL of the vehicle width (refer to FIG. 3) as the high-voltage electric wire 120 (refer to FIG. 2) in the vehicle width direction. The inlet port 93 is provided above the outlet port 92. The inlet port 93 is provided in an upper portion of the down tube 19. The inlet port 93 opens on the side opposite to the outlet port 92 in the vehicle width direction.

The pump 95 circulates the cooling water between the storage portion 91 and the power unit 8. The pump 95 is disposed on the same side of the center CL of the vehicle width as the high-voltage electric wire 120 in the vehicle width direction. That is, the pump 95 is disposed on the same side of the center CL of the vehicle width as the outlet port 92 in the vehicle width direction. The pump 95 is disposed below the outlet port 92. The pump 95 has an impeller therein. The pump 95 is disposed so that a rotation axis of the impeller extends in the vertical direction. The pump 95 includes a suction portion and a discharge portion. The suction portion protrudes upward from a casing of the pump 95. The discharge portion protrudes inward from the casing of the pump 95 in the vehicle width direction. The pump 95 is supported by the down tube 19 via a pump stay 48 which extends from the down tube 19.

The pipe 97 includes a first pipe 97A which connects the power unit 8 to the storage portion 91, a second pipe 97B which connects the storage portion 91 to the suction portion of the pump 95, and a third pipe 97C which connects the discharge portion of the pump 95 to the power unit 8. The pipe 97 is connected to the power unit 8 on the side of the center CL of the vehicle width opposite to the high-voltage electric wire 120.

The first pipe 97A guides the cooling water discharged from the power unit 8 to the storage portion 91. The first pipe 97A is connected to the discharge port 57 of the motor case 54 and the inlet port 93 of the storage portion 91. The entire portion of the first pipe 97A extends from the discharge port 57 toward the inlet port 93 in a horizontal direction or upward from the horizontal. The first pipe 97A is disposed below the left main pipe 17 in a side view. The first pipe 97A passes through the outside from the left gusset 21 in the vehicle width direction and straddles the left gusset 21.

The second pipe 97B guides the cooling water flowing out from the storage portion 91 to the pump 95. The second pipe 97B is connected to the outlet port 92 of the storage portion 91 and the suction portion of the pump 95. The entire portion of the second pipe 97B extends from the outlet port 92 toward the pump 95 in the horizontal direction or downward from the horizontal.

The third pipe 97C guides the cooling water discharged from the pump 95 to the power unit 8. The third pipe 97C is connected to the discharge portion of the pump 95 and the introduction port 85 of the PCU case 81. The third pipe 97C extends in the vehicle width direction to intersect the center CL of the vehicle width behind the down tube 19. The third pipe 97C extends from the discharge portion of the pump 95 along a front surface of the battery 100, then extends along an upper surface of the lower battery 102 and a left surface of the upper battery 106, further extends along a rear surface of the lower battery 102 and a left surface of the motor 50 and is connected to the introduction port 85 of the power unit 8.

As described above, the electric motorcycle 1 of the embodiment includes the vehicle body frame 5 in which the storage portion 91 in which the cooling water flowing through the power unit 8 is stored is formed. According to such a constitution, it is possible to increase a storage amount of the cooling water without separately providing a tank or the like for storing the cooling water in a location other than the vehicle body frame 5. Therefore, an increase in the storage amount of the cooling water and a reduction in the number of components can be promoted, and the cooled cooling water can be supplied to the power unit 8 at a necessary timing.

Further, the inlet port 93 of the storage portion 91 is provided above the outlet port 92. According to the such a constitution, the high-temperature cooling water returned from the power unit 8 to the storage portion 91 can remain above the outlet port 92 in the storage portion 91 due to a density difference based on a temperature difference of the cooling water. Therefore, even in a state in which the cooling water heated in the power unit 8 is returned to the storage portion 91, relatively low-temperature cooling water can be supplied from the storage portion 91 to the power unit 8. Thus, the cooled cooling water can be supplied to the power unit 8 at a necessary timing.

Further, a part of the power unit 8 is disposed between the main pipes 17 and the down tube 19. The storage portion 91 is formed in the down tube 19. According to such a constitution, since the storage portion 91 is close to the power unit 8, it is possible to avoid an increase in a length of the pipe 97 and to curb an increase in a weight of the vehicle.

Further, the high-voltage electric wire 120 is disposed on the right side of the center CL of the vehicle width. The pump 95 is disposed on the same side of the center CL of the vehicle width as the high-voltage electric wire 120. The pipe 97 is connected to the power unit 8 on the side of the center CL of the vehicle width opposite to the high-voltage electric wire 120. According to such a constitution, as compared with a case in which the pipe is connected to the power unit 8 on the same side of the center CL of the vehicle width as the high-voltage electric wire 120 and the pump 95, it is possible to suppress the weight balance between the right and left sides of the vehicle from being biased.

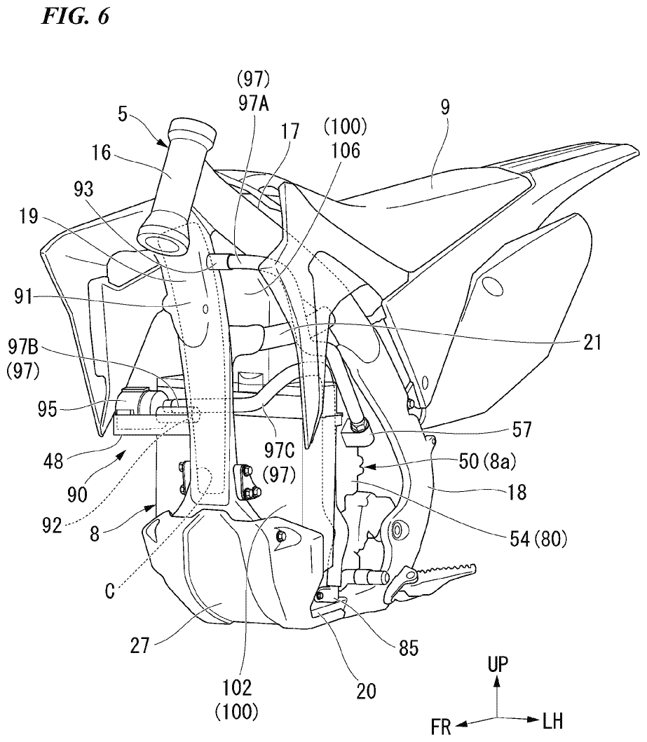

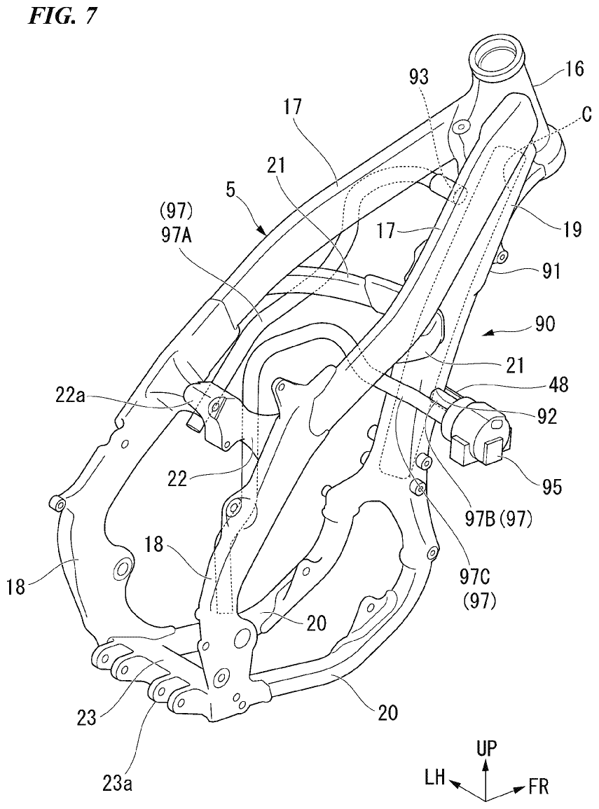

Also, positions of the outlet port 92 and the inlet port 93 of the storage portion 91 is not limited to the example of the embodiment. For example, as shown in FIGS. 6 and 7, the outlet port 92 may be provided in a lower portion of the down tube 19. In this way, the larger a gap between the outlet port 92 and the inlet port 93 is, the larger the storage amount of the cooled cooling water which can be supplied to the power unit 8 can be secured.

Further, an arrangement of the pump 95 is also not limited to the example of the above-described embodiment. For example, as shown in FIGS. 6 and 7, the pump 95 may be disposed so that the rotation axis of the impeller extends in the vehicle width direction.

### Second Embodiment

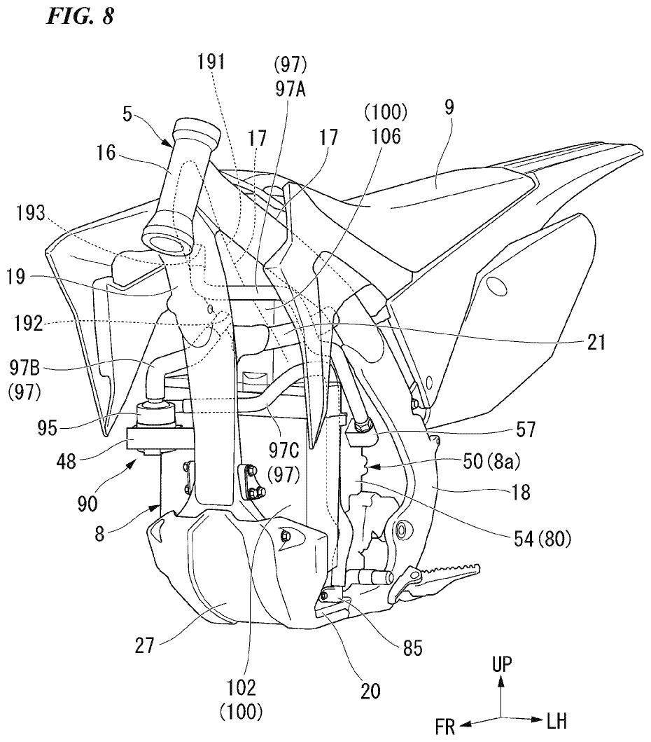

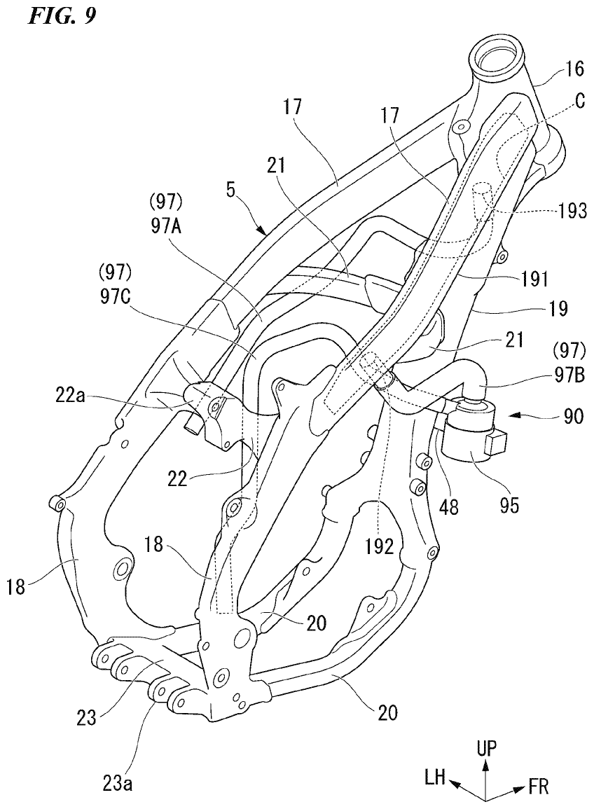

Next, a second embodiment will be described with reference to FIGS. 8 and 9. The second embodiment is different from the first embodiment in that the storage portion 191 is formed in the main pipe 17. The constitutions other than those described below are the same as those in the first embodiment.

FIG. 8 is a perspective view of a part of the electric motorcycle according to the second embodiment when seen from the left front side. FIG. 9 is a perspective view of a vehicle body frame and a cooling system in the electric motorcycle according to the second embodiment when seen from the right rear side. As shown in FIGS. 8 and 9, a storage portion 191 of the embodiment is formed in one main pipe 17. In the shown example, the storage portion 191 is formed in the right main pipe 17. The storage portion 191 is formed by allowing the cooling water to be stored inside the right main pipe 17. For example, a cavity C of the storage portion 191 extends continuously from a front end portion of the main pipe 17 to a rear end portion thereof. That is, the storage portion 191 is provided from the front end portion of the main pipe 17 to the rear end portion thereof. The cavity C of the storage portion 191 is an independent cavity which is not in communication with other cavities in the vehicle body frame 5.

The storage potion 191 includes an outlet port 192 through which the cooling water flows out toward the power unit 8, and an inlet port 193 through which the cooling water discharged from the power unit 8 flows in. A pipe 97 is connected to the outlet port 192 and the inlet port 193. The outlet port 192 and the inlet port 193 communicate with the inside and outside of the storage portion 191, respectively. The outlet port 192 is provided in a lower surface of a rear end portion of the main pipe 17. The outlet port 192 opens downward. The inlet port 193 is provided above and in front of the outlet port 192. The inlet port 193 is provided in a lower surface of a front portion of the main pipe 17. The inlet port 193 opens downward.

The first pipe 97A guides the cooling water discharged from the power unit 8 to the storage portion 191. The first pipe 97A is connected to the discharge port 57 of the motor case 54 and the inlet port 193 of the storage portion 191. The entire portion of the first pipe 97A extends from the discharge port 57 toward the inlet port 193 in the horizontal direction or upward from the horizontal. The first pipe 97A is disposed below the left main pipe 17 in a side view. The first pipe 97A passes through the outside from the left gusset 21 in the vehicle width direction and straddles the left gusset 21. The first pipe 97A extends in the vehicle width direction to intersect the center CL of the vehicle width in front of the upper battery 106 and behind the down tube 19.

The second pipe 97B guides the cooling water flowing out from the storage portion 191 to the pump 95. The second pipe 97B is connected to the outlet port 192 of the storage portion 191 and the suction portion of the pump 95. The entire portion of the second pipe 97B extends from the outlet port 192 toward the pump 95 in the horizontal direction or downward from the horizontal.

As described above, in the embodiment, since the storage portion 191 is formed in the vehicle body frame 5, the same effects as those in the above-described first embodiment can be achieved. In particular, in the embodiment, since the storage portion 191 is formed in the main pipe 17, the storage portion 191 is close to the power unit 8. Therefore, it is possible to avoid an increase in a length of the pipe 97 and to curb an increase in a weight of the vehicle.

### Third Embodiment

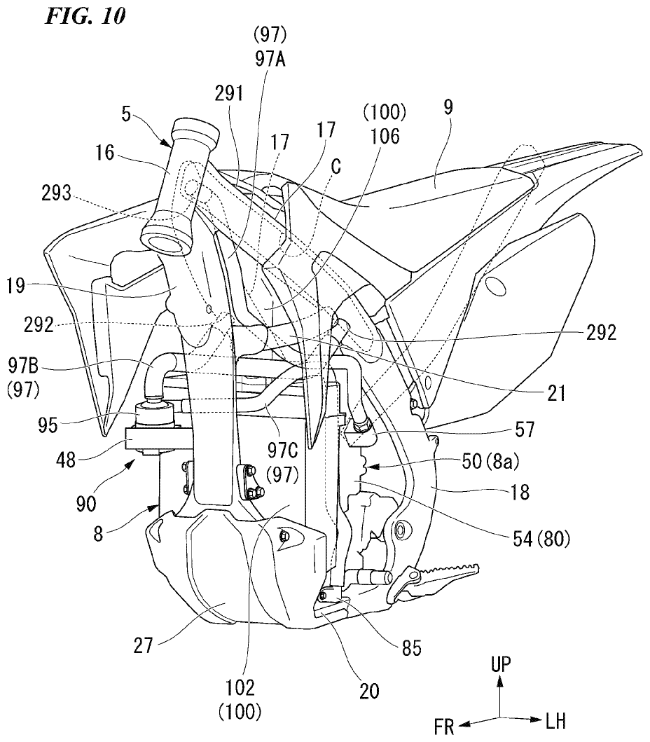

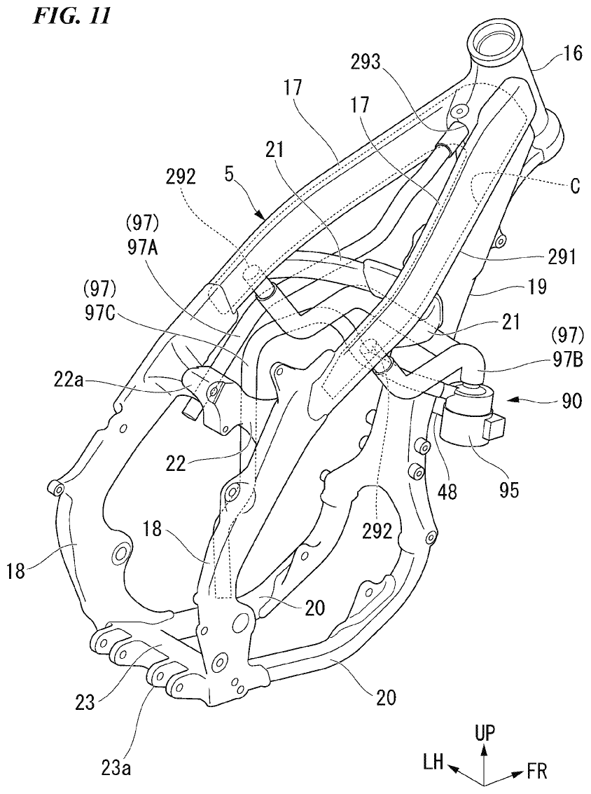

Next, a third embodiment will be described with reference to FIGS. 10 and 11. The third embodiment is different from the second embodiment in that the storage portion 291 is formed in the pair of main pipes 17. The constitutions other than those described below are the same as those in the second embodiment.

FIG. 10 is a perspective view of a part of the electric motorcycle according to the third embodiment as viewed from the left front. FIG. 11 is a perspective view of the body frame and the cooling system in the electric motorcycle according to the third embodiment as viewed from the right rear. As shown in FIGS. 10 and 11, the storage portion 291 of the embodiment is formed in the pair of main pipes 17. The storage portion 291 is formed by allowing the cooling water to be stored inside the pair of main pipes 17. For example, a cavity C of the storage portion 291 continuously extends from the front end portion to the rear end portion of each of the pair of main pipes 17. The cavities of the pair of main pipes 17 communicate with each other at the front end portions of the pair of main pipes 17. That is, the cavity C of the storage portion 291 extends from the rear end portion of one main pipe 17 to the rear end portion of the other main pipe 17 via a coupling portion between the front end potions of the pair of main pipes 17. The cavity C of the storage portion 291 does not communicate with other cavities in the vehicle body frame 5.

The storage potion 291 includes a pair of outlet ports 292 through which the cooling water flows out toward the power unit 8, and an inlet port 293 through which the cooling water discharged from the power unit 8 flows in. A pipe 97 is connected to the outlet ports 292 and the inlet port 293. The outlet ports 292 and the inlet port 293 communicate with the inside and outside of the storage portion 291, respectively. Each of the outlet ports 292 is provided in a lower surface of a rear end portion of each of the pair of the main pipes 17. The outlet port 292 open downward. The inlet port 293 is provided above and in front of the outlet port 292. The inlet port 293 is provided in a lower surface of the coupling portion of the pair of the main pipes 17. The inlet port 293 opens rearward.

The first pipe 97A guides the cooling water discharged from the power unit 8 to the storage portion 291. The first pipe 97A is connected to the discharge port 57 of the motor case 54 and the inlet port 293 of the storage portion 291. The entire portion of the first pipe 97A extends from the discharge port 57 toward the inlet port 293 in the horizontal direction or upward from the horizontal. The first pipe 97A passes through the outside from the left gusset 21 in the vehicle width direction and straddles the left gusset 21. The first pipe 97A passes below the left main pipe 17 and straddles the left main pipe 17 in the vehicle width direction.

The second pipe 97B guides the cooling water flowing out from the storage portion 291 to the pump 95. The second pipe 97B is formed in a Y shape and is connected to the pair of outlet ports 292 of the storage portion 291 and the suction portion of the pump 95. The second pipes 97B extend from each of the pair of outlet ports 292 toward the outside of the battery 100 in the vehicle width direction, then are coupled to each other in front of the battery 100 and connected to the pump 95. The entire portion of the second pipe 97B extends from the outlet ports 292 toward the pump 95 in the horizontal direction or downward from the horizontal.

As described above, in the embodiment, since the storage portion 291 is formed in the vehicle body frame 5, the same effects as those in each of the above-described embodiments can be achieved. In particular, in the embodiment, since the storage portion 291 is formed in the pair of main pipes 17, the storage amount of the cooling water can be further increased, as compared with the case in which the storage portion is formed only on one main pipe 17.

The present invention is not limited to the above-described embodiments described with reference to the drawings, and various modified examples can be considered within the technical scope thereof. For example, in the above embodiment, the application to an electric motorcycle for off-road traveling has been described as an example, but the use of the vehicle is not limited at all.

For example, the saddle type electric vehicle includes all vehicles on which a driver rides across a vehicle body and also includes a motorcycle but also a three-wheeled vehicle having one front wheel and two rear wheels and a three-wheeled vehicle having two front wheels and one rear wheel.

Further, in the above-described embodiments, although the storage portion is formed in the down tube 19 or the main pipe 17, the present invention is not limited thereto. The storage portion may be formed in both the down tube 19 and the main pipes 17. That is, the cavities of the down tube 19 and the main pipe 17 may be communicated with each other to form a cavity of the storage portion. Also, the storage portion may be formed in the pivot frame 18, the lower frame 20, the gusset 21, the seat rail 24, the support rail 25, or the like.

Moreover, in the above-described embodiments, although the cavity of the storage portion continuously extends between the both ends of the down tube 19 or the main pipe 17, the present invention is not limited thereto. The cavity of the storage portion may be only a part partitioned by a partition member inside the down tube 19 or the main pipe 17.

Moreover, in the above-described embodiments, although the cooling system 90 is constituted so that the motor 50 and PCU 130 in the power unit 8 are cooled, it may be configured so that the battery 100 is cooled.

Furthermore, in the above-described embodiments, the pump 95 is disposed on the same side of the center CL of the vehicle width as the high-voltage electric wire 120 in the vehicle width direction. However, the present invention is not limited thereto, and the arrangement may be adjusted as appropriate according to the shape, position, or the like of the storage portion.

While preferred embodiments of the invention have been described and shown above, it should be understood that these are exemplary of the invention and are not to be considered as limiting. Additions, omissions, substitutions, and other modifications can be made without departing from the scope of the present invention. Accordingly, the invention is not to be considered as being limited by the foregoing description, and is only limited by the scope of the appended claims.

### EXPLANATION OF REFERENCES

1 Electric motorcycle (saddle type electric vehicle)
2 Front wheel
5 Vehicle body frame
8 Power unit
16 Head pipe
17 Main pipe
19 Down tube
50 Motor
91, 191, 291 Storage portion
92, 192, 292 Outlet port
93, 193, 293 Inlet port
95 Pump
97 Pipe
100 Battery
130 PCU (control unit)

What is claimed is:

1. A saddle type electric vehicle comprising:
a power unit including a motor which is configured to drive the vehicle, a battery which is a power source of the motor, and a control unit which is configured to control the motor; and
a vehicle body frame which supports the power unit and in which a storage portion configured to store cooling water flowing through an inside of the power unit is formed.

2. The saddle type electric vehicle according to claim 1, wherein the storage portion includes an outlet port through which the cooling water flows out toward the power unit, and an inflow port which is provided above the outlet port and through which the cooling water discharged from the power unit flows in.

3. The saddle type electric vehicle according to claim 1, wherein:
the vehicle body frame includes a head pipe which supports a front wheel to be steerable, a pair of right and left main pipes which extend rearward from the head pipe, and a down tube which extends downward from the head pipe,
at least a part of the power unit is disposed between the pair of main pipes and the down tube, and
the storage portion is formed in at least one of the main pipes and the down tube.

4. The saddle type electric vehicle according to claim 1, further comprising:
a pipe which connects the storage portion to the power unit and in which the cooling water flows;
a pump which is configured to circulate the cooling water between the storage portion and the power unit; and
a high-voltage electric wire which extends from the battery,
wherein the high-voltage electric wire is disposed on one side of a center of a vehicle width in a vehicle width direction,
the pump is disposed on the same side of the center of the vehicle width as the high-voltage electric wire, and
the pipe is connected to the power unit on a side of the center of the vehicle width opposite to the high-voltage electric wire.

5. The saddle type electric vehicle according to claim 2, wherein:
the vehicle body frame includes a head pipe which supports a front wheel to be steerable, a pair of right and left main pipes which extend rearward from the head pipe, and a down tube which extends downward from the head pipe,
at least a part of the power unit is disposed between the pair of main pipes and the down tube, and
the storage portion is formed in at least one of the main pipes and the down tube.

6. The saddle type electric vehicle according to claim 2, further comprising:
a pipe which connects the storage portion to the power unit and in which the cooling water flows;
a pump which is configured to circulate the cooling water between the storage portion and the power unit; and
a high-voltage electric wire which extends from the battery,
wherein the high-voltage electric wire is disposed on one side of a center of a vehicle width in a vehicle width direction,
the pump is disposed on the same side of the center of the vehicle width as the high-voltage electric wire, and
the pipe is connected to the power unit on a side of the center of the vehicle width opposite to the high-voltage electric wire.

7. The saddle type electric vehicle according to claim 3, further comprising:
a pipe which connects the storage portion to the power unit and in which the cooling water flows;
a pump which is configured to circulate the cooling water between the storage portion and the power unit; and
a high-voltage electric wire which extends from the battery,
wherein the high-voltage electric wire is disposed on one side of a center of a vehicle width in a vehicle width direction,
the pump is disposed on the same side of the center of the vehicle width as the high-voltage electric wire, and
the pipe is connected to the power unit on a side of the center of the vehicle width opposite to the high-voltage electric wire.

8. The saddle type electric vehicle according to claim 5, further comprising:
a pipe which connects the storage portion to the power unit and in which the cooling water flows;
a pump which is configured to circulate the cooling water between the storage portion and the power unit; and
a high-voltage electric wire which extends from the battery,
wherein the high-voltage electric wire is disposed on one side of a center of a vehicle width in a vehicle width direction,
the pump is disposed on the same side of the center of the vehicle width as the high-voltage electric wire, and
the pipe is connected to the power unit on a side of the center of the vehicle width opposite to the high-voltage electric wire.
